(19) United States
(12) Patent Application Publication
(10) Pub. No.: US 2022/0072642 A1
(43) Pub. Date: Mar. 10, 2022

(54) METHODS AND APPARATUS FOR METAL STRUCTURE FABRICATION

(71) Applicant: Gerard McWeeney, Huntington Beach, CA (US)

(72) Inventor: Gerard McWeeney, Huntington Beach, CA (US)

(21) Appl. No.: 17/469,855

(22) Filed: Sep. 8, 2021

Related U.S. Application Data
(60) Provisional application No. 63/222,923, filed on Jul. 16, 2021.
(60) Provisional application No. 63/075,399, filed on Sep. 8, 2020.

(51) Int. Cl. B23K 5/213; B23K 9/235

(52) U.S. Cl. CPC B23K 5/213; B23K 2101/12; B23K 9/235

(57) ABSTRACT

Disclosed is a temporary and mobile apparatus and methods for manufacturing welded products, including pressure vessels, wherein heating and/or cooling is to be applied to substrate material of the weld site. Certain embodiments include panels arranged to form a convection section that allows for improved heating and cooling of substrates and provide improved welding processes. Embodiments can include a manifold along used for heating and cooling. Apparatuses and methods of using making those apparatuses for improved welding are described herein.

### CROSS-REFERENCE TO RELATED APPLICATIONS

This application claims the benefit of U.S. Provisional Application No. 63/222,923 filed on Jul. 16, 2021 and U.S. Provisional Application No. 63/075,399 filed on Sep. 8, 2020, the disclosure of each of which is incorporated herein by reference.

### FIELD OF INVENTION

The invention relates generally to welded components and metallurgy, and, particularly the pre- and post-heat treatment to welding of pressurized containers.

### BACKGROUND OF ART

Storing and transporting various materials, such as gas and liquids, by road, rail and sea under pressure and/or refrigeration can present problems due to weight, potential failure, and/or cost of the pressure vessel systems. Materials used in the manufacture of such vessels are heavy and are prone to corrosion and weakening. The vessels can also be limited to usage at near ambient storage temperatures as the potential danger for brittle/ductile failure exists due to Joule Thompson effects caused by decompression.

Manufacturing and building these large structures, especially pressure vessels, provides various challenges during assembly. For example, welding portions of the walls or panels of the structures require significant resources, including, but not limited to, workers, time, energy, non-structural materials, and safety equipment. This is because the welds require certain steps be taken to provide a sound structure, e.g., pressure vessels used in the oil industry.

Many industries use pressure vessels for transporting, transferring and/or storing various materials under high pressure, e.g., gas or liquid. Given the applications of pressure vessels, welds undergo considerable quality inspections, including X-rays and certifications. If the weld fails the inspections, then the weld is removed and replaced with a patch. Given high demands for such vessels in these industries, a failed weld is costly. Thus, material preparation and proper welding techniques are necessary to avoid lost profits and wasted resources.

Material preparation can include preheating all or portions of the vessel walls or components of the vessel walls that are to be welded together. Such preparation requires proper placement of heating components and insulating components because the weld placements are important for creating welds that meet manufacturer's design specifications and pass inspection. In currently practiced methods of manufacturing such vessels, excessive time must be taken for allowing materials to cool after heating to allow personnel to further manipulate the metals. In other situations, time is lost in pretreating metals with heat in preparation for welding. What is needed to address this and other issues is a temporary, mobile apparatus for weld preparation and completion to address loss of resources, such as loss of time, space, and fabrication production due to the impossibility of workers beginning or continuing work on the subject materials due to high temperatures. These needs are addressed by the present invention.

### SUMMARY

Provided herein are embodiments of the invention providing a temporary and mobile convection apparatus and methods related weld projects requiring weld preparation and/or completion.

In some embodiments, an apparatus and methods are provided for pre-heating substrate materials for joining portions of a vessel body, and/or mechanical lining, for mechanical strength of a welded joint portion, and giving options for shape of the weld joint portion and position. Certain embodiments of the invention provide an apparatus and methods for pre-heating substrate materials and maintaining the pre-heat temperatures throughout the welding of the substrate materials. Embodiments of the invention provide an apparatus and methods for reducing resources required for achieving and maintaining pre-heated temperatures for the welding.

In some embodiments, a temporary, mobile convection apparatus is provided, wherein convection occurs internal to a space created by the convection apparatus. In further embodiments, panels (barrier or walls) form a convection section of the convection apparatus. In one embodiment, a convection apparatus of the invention can have a manifold, wherein a pipe or pipes of the manifold are housed within the internal space of the convection apparatus as the apparatus is temporarily affixed to or abutted with the substrate materials being treated and/or welded. Some embodiments of the invention provide terminus throttles for aiding in pre-heating, maintaining a desired pre-heated temperature, or cooling of substrate materials for the weld exposed to an interior area of the convection section of the convection apparatus. Various embodiments provide an extension to the manifold for purposes of attachment to heating and/or cooling equipment. Additional embodiments include heating and/or cooling equipment for attachment to the manifold of the convection apparatus. Some embodiments of the invention have one or more manifolds coated with a thermal barrier. In yet other embodiments, the materials, lengths and dimensions of the manifold components can be varied to address the requirements of the job. In some embodiments, there can be one, two or more manifolds provided as part of the convection apparatus.

Certain embodiments of the invention provide a convection apparatus for placement internally or externally to a pressure vessel or other equipment. In certain embodiments, insulation and heating elements are provided for pre-heating and maintaining the achieved temperature of a substrate material for welding. In various embodiments, the heating elements with insulation can be placed external or internal to the vessel, and can be positioned to form a heated band and heating gradient bands in relevant locations to a weld site of the substrate materials.

The present invention provides embodiments of an apparatus and methods for fabrication or repair of pressure vessels and other products requiring welds.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a side view of various embodiments of the present invention assembled for purposes of one type of pre-heat of substrate materials of a weld.

FIG. 2 is (2a) a side view of a convection apparatus constructed according to certain principles of the invention, and (2b) a side view of an apparatus without a convection aspect as known in the prior art.

FIG. 3 is a side view of a manifold system according to certain principles of the invention.

FIGS. 4(a) and 4(b) depict heating elements positioned around a piece of steel wrapped in portions of ceramic fiber.

FIGS. 5(a) and 5(b) depict the installation of ceramic fiber inside of steel used in Trial 1. The ceramic fiber was supported and held in position using wire mesh.

FIGS. 6(a) and 6(b) depict the installation of ceramic fiber inside of steel used in Trial 1. The ceramic fiber was supported and held in position using wire mesh.

FIGS. 7(a) and 7(b) depict the installation of ceramic fiber inside of steel used in Trial 2 prior to the installation of internal panels. The ceramic fiber was supported and held in position using wire mesh.

FIGS. 8(a) and 8(b) depict internal panels made in accordance with the disclosure contained herein positioned inside of a piece of steel used for Trial 2

FIGS. 9(a) and 9(b) depict a piece of steel covered in panels in accordance with embodiments of the present invention and including a blower positioned on the panels

FIG. 10 is a graph showing temperature as a function of time produced as a result of the test in Trial 1.

FIG. 11 is a graph showing temperature as a function of time produced as a result of the test in Trial 2.

FIG. 12 is a graph showing the data produced via Trial 3.

FIG. 13 is a graph comparing the results of Trials 1-3.

FIGS. 14(a) and 14(b) depict an embodiment containing an angled portion of a manifold inlet.

FIGS. 15(a) and 15(b) depict a slidable end vent positioned on a panel in accordance with the disclosure.

FIG. 16(a) depicts a spring-loaded end vent for a panel made in accordance with the disclosure.

FIG. 16(b) shows an isometric view of a valve flap for a spring-loaded end vent made in accordance with the disclosure.

FIG. 16c shows a top view of a valve flap made for use in conjunction with a spring-loaded end vent.

FIG. 16d shows a bracket cutout for a spring-loaded valve flap.

### DETAILED DESCRIPTION OF THE PREFERRED EMBODIMENTS

Various embodiments of the present invention are illustrated and/or explained herein.

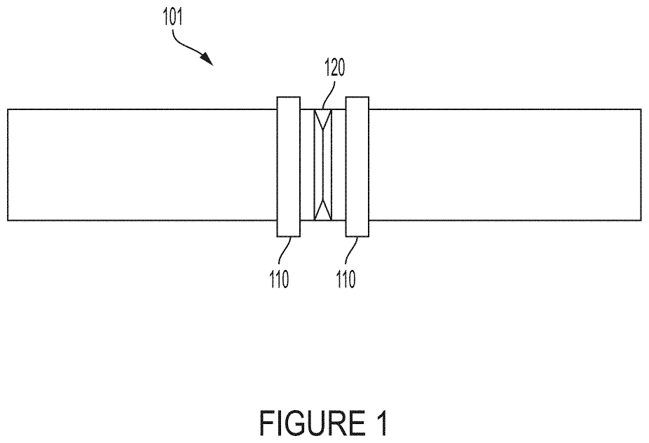

FIG. 1 provides an embodiment of the invention. As shown, a temporary, mobile convection apparatus is provided in relation to a substrate material, e.g., sections of pipes 101. A weld site or area 120 is provided, showing where sections of pipes 101 are to be joined via a weld at 120. Pipe 101 may comprise a convention section that is positioned on either side of the weld site or area 120. As described herein, a convection section is positioned in proximity to weld site or area 120 for multiple purposes. One purpose can be to pre-heat the substrate material of pipes 101 to be welded together. As will be appreciated by those in the art, the requirements of any job will determine whether one or more convection sections are required. For example, small jobs may only require or provide for use of one convection section in close proximity to weld site or area 120. By way of example, FIG. 1 illustrates the use of two convection sections, with one on each side of weld site or area 120 for pre-heating the substrate material of pipes 101 to be welded together. As shown, convection sections can be configured to encompass a portion or the entire circumference (360 degrees) of pipes 101 on each side of weld site or area 120. Heat is applied into convection sections or boxes 110 to control the pre-heat weld temperature. Conversely, convection sections or boxes 110 could be used for passing cooled air through the internal space of convection sections or boxes 110 to control the weld interpass temperature. Certain aspects of the embodiments shown in FIG. 1 are discussed and described in more detail herein. As should be appreciated by the skilled artisan, weld sites or areas as described herein are not covered by any apparatus described herein during the pre-heating, maintaining of pre-heating temperatures for welding, or during post-weld cooling.

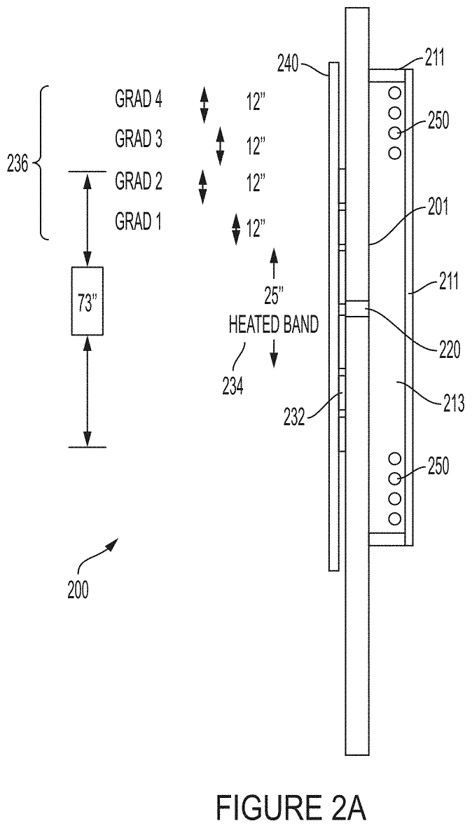

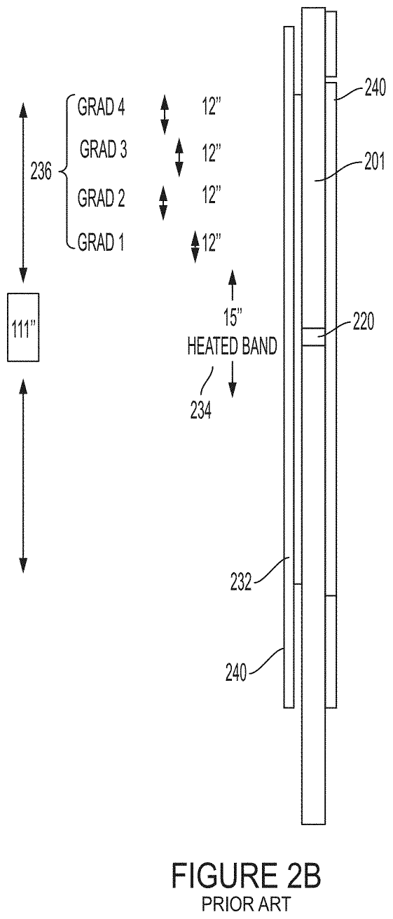

FIG. 2a shows a side view of a vessel wall 201 with an internal convection apparatus. The convection apparatus in this embodiment is a convection section, wherein convection section 200 comprises a panel 211 (e.g., barrier or wall). The convection apparatus is a temporary, mobile convection apparatus forming an internal space or internal convection space 213 to provide internal convection of heated or cooled air as provided herein. Unless otherwise provided herein, the term “internal convection” refers to convection occurring within the internal space 213 created by the convection apparatus being affixed to or abutted against, around and/or on the substrate materials to be welded, being welded, or cooling from being welded, such as the vessel wall 201. The convection section provides a panel 211 (barrier or wall) to form a desired shape of a convection section. The convection section can be comprised of multiple panels 211, wherein the convection apparatus is mobile for temporary construction, placement, and removal. The panels 211 of the convection section 210 can be manufactured with low grade aluminum or other materials such as steel, as will be appreciated by those in the field. The panels 211 of the convection section 210 can have a high temperature coating. The high temperature coating is designed to contain the heat within the convection box and limit heat loss through the panels 211 of the convection section 210. As an example, the coating is a lightweight, high performance, high temperature thermal insulating barrier coating. High temperature coating can also comprise an insulating material like lightweight refractory. Desirable characteristics of the coatings used in the present invention can include: 1) a shock cool from 1000 F to 77 F; 2) direct flame resistance of 15 minutes at 2000 F; 3) thermal lag of 1,200 F temperature drop after 20 minutes on a 15 mil coating in freely circulating air; 4) maximum temperature of 210 F through coating after 60 minutes exposure to 300 F heat source; 5) maximum temperature of 535 F after 60 minutes exposure to 1000 F heat source; and 6) a thermal conductivity of KC at 600° F.-1.8 BTU/hr/ft., 2 deg F./in and KC at 900° F.-2.2 BTU/hr/ft., 2/deg F./in. One example of such coating is the PT-209C Caliente High Temperature Thermal Lag.

Certain embodiments can also provide an external heating system. The heating system can be adapted to be positioned on a side of vessel wall 201 opposite the internal convection box 210. The external heating system can comprise one or more external heating components or heating elements 232. The heating system is positioned in a manner to create required heated bands of various temperature gradients over a required area of the specific product being fabricated. By way of example, through the use of convection section, the heating elements 232 in the heated band's 234 width will increase by at least 67% over that of other methods, and the heating elements 232 in the gradient band 236 widths will decrease by about 40%. In some embodiments, the convention section can be structured as a box surrounding the portion of the vessel wall to be heated, and may be referred to as a convection box. However, the shape of the convection section is not particularly limited and one of skill in the art would envisage how to modify the shape of the convection section to heat and cool the product (i.e., substrate) being fabricated and/or welded. The heating elements 232 in the gradient bands 236 can be used in series thereby greatly reducing the power requirements and costs of the embodiments of the present invention compared to prior art devices. One of skill in the art would immediately envisage the types of heating elements that could be used to heat the substrate and the convection section. The heating elements can be flexible ceramic pads or electrical resistance heating elements and the like. These heating elements can be sized to accord with any given weld project, and can be, for example, 80 volt, 45 amp, 3.6 KW heating elements. As seen in FIG. 2a and by way of example, gradient bands 236 are utilized, wherein the outer two gradient bands, e.g., gradient bands 3 and 4 (GRAD 3 and GRAD 4), achieve temperature control with use of external insulation 240 and through heat from the internal space 213 of convection section. The internal convection section reduces the external heater requirements by over 30% without impacting the quality of the heat treatment.

Also provided is external insulation 240 positioned on a side opposite the internal space 213 of convection section. The external insulation 240 is also positioned to insulate the external heating system, wherein the external heating system is between the external insulation 240 and vessel wall 201 sections to be welded. The external insulation 240 is adapted to cover the external heaters 232, including extending beyond the ends of the external heaters 232 to varying lengths as required by the convection section set up. Length and size of the external insulation 240 will be determined based on the width of the heated band 234 and gradient bands 236. The choice of external insulation 240 can be made based on the size, cost and requirements of the fabrication job to be performed. By way of example, welding blankets can be used to direct the heat into the metal being prepared for a weld. The external insulation 240 material can be attached or connected to each other via heavy insulated fiberglass heating tapes as necessary and/or affixed to vessel wall 201.

Illustrated in FIG. 2b is a known prior art method of pre-heating a substrate material, e.g., vessel wall 201. As noted, heated band 234 is much narrower than the heated band of an embodiment of the invention (e.g., shown in FIG. 2a), which results in wasted resources such as electricity and work time for placement of external heater system. This problem is overcome by use of the convection section of FIG. 2a, which requires less external heater elements 232. In FIG. 2b, external insulation 240 is positioned to each side of a substrate material to preheat for welding, e.g., vessel wall 201. Insulation 240 on the opposite side of vessel wall 201 from external heating elements 232 does not produce a convection action as with convection section of FIG. 2a. Thus, embodiments of the instant invention improve over the prior art because they do not position insulation on the same side of the substrate where heating elements are located. This positioning can produce the improved results discussed herein, including the improved heating and cooling that is the result of the convection created by the convection section. The number and/or size of external heating elements 232 of external heater system in FIG. 2b is also larger than that required in the embodiments of the invention in FIG. 2a. Therefore, more resources are required in using a configuration seen in FIG. 2b. Embodiments of the invention avoid this unnecessary requirement of additional time and other resources.

It should be appreciated that the temporary, mobile convection apparatus of FIG. 2a can be used in pre-heating, maintaining a desired temperature from pre-heating for the weld job, and for cooling the substrate materials in the fabrication of welded products. All aspects of the pre-heating, maintaining of pre-heat temperatures, and cooling can utilize manifolds 250. Manifold 250 can be positioned as required by specifications of each job. Depending on the product and/or job, there can be one, two or more manifolds 250. Manifolds can be heated using a heater configured to blow or convey hot air into the manifold, such as a commercially available gas and air propane mix burner.

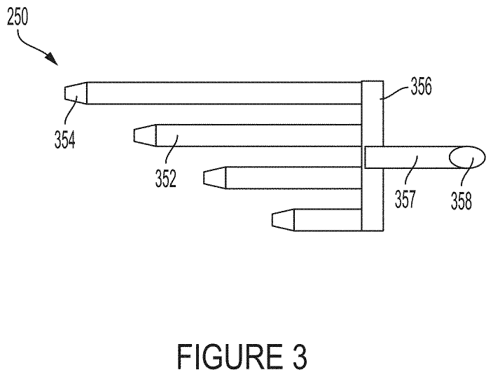

In FIG. 3, one embodiment of a manifold 250 is provided. Manifold 250 can serve as a heating or cooling system for the temporary, mobile convection apparatus 200. Manifold 250 can reside primarily within the internal space 213 of the convection section or box 210. The manifold 250 is adapted to rapidly and effectively cool the substrate material exposed to internal space 213 of the convection section or box 210. Conversely, manifold 250 is also adapted to aid in rapidly and effectively heating the substrate material exposed to internal space 213 of convection section or box 210.

The manifold's 250 cooling reduces steel temperature more rapidly than controlled cooling by about 15% to about 40%; about 20% to about 35%; about 30% to about 33%; and any individual % points or ranges in between each. This rapid cooling allows for considerable reduction in time compared to normal procedures for allowing access for further work that occurs after heat treatment has been completed. For example, after the welding is completed, a temperature of a welded section could be thousands of degrees Fahrenheit (° F.), e.g., 1600° F. Before workers can return to begin post-weld work and modifications, the welded section must achieve an ambient or similarly workable temperature. To achieve this ambient or similar temperature under practiced methods in the field, the temperature of the welded section undergoes a control cooling down to ambient or similarly workable temperature. Through embodiments of the invention, the temperature of the welded section is control-cooled to approximately 800-600° F., and then a temporary, mobile convection apparatus 200 of the invention is used to rapidly cool the temperature from 800-600° F. down to ambient or similarly workable temperatures. By this process, workers gain access to the weld area sooner to continue work in the relevant sections of the vessel, and clients can return to production more rapidly. The manifold 250 can be used for chilling or cooling the heated substrate material and can also be used for heating, as discussed herein regarding pre-heating. The material of the manifold 250 can vary depending on the job requirements, and the various components or portions of the manifold 250 can be made of different materials. By way of example, the manifold 250 can be manufactured from SCH 40 stainless steel or copper tubing.

A manifold 250 of the invention can have one or more pipes 352 of various lengths to be determined based on the requirements of the job. By way of example, FIG. 3 shows four pipes 352. The diameter of the pipes 352 can also vary depending on the project requirements. When required, manifold 250 may require two or more pipes 352. Where two or more pipes 352 are required, then pipes 352 are in fluid communication through a cross-pipe 356, which can be of the same or different diameter and same or different material than pipes 352. By way of example, the pipes 352 can be a 1 inch standard wall pipe. In certain scenarios, a lighter weight material is chosen for the temporary, mobile convection apparatus 200. Each pipe 352 is capped with a throttle 354 adapted to properly vent hot or cold air passing through the pipes 352. By way of example, a ¾ inch throttle 354 can be used with the 1 inch diameter pipe 352. As described herein, each pipe 352 can be capped with a throttle 354.

In the case of cooling the heated substrate materials, e.g., metal, a cooling device is attached (e.g., via a flange connection) to an extension portion 357 of the manifold 250, wherein the extension portion 357 passes through the convection section to panel 211 from the interior of the convection section to the outside of the convection section to connect to the cooling device (not shown). The extension portion 357 can have an angled portion 358 (e.g., 90 degrees) for orienting and connecting to the cooling device. The size and requirements of the cooling device will be determined based on the size of the project and cool down specifications. By way of example, a 10 ton air-cooled chiller, or other similar chillers, or industrial air-conditioning units can be used.

As exemplified in FIG. 3, the invention also provides for using the manifold 250 for pre-heating the substrate material, e.g., metal of vessel wall 201, for welding, wherein pre-heating is utilized prior to the weld as described herein. In this manner, the manifold 250 is used to pass heated or cooled air through the internal space 213 of the convection section. In cases of using the manifold 250 for pre-heating the substrate materials, the manifold extension portion 357, with or without angled portion 358, can be attached to a heating unit. Various aspects of the manifold 250 are adaptable for attachment to differing heating units. Likewise, post-weld temperature treatments are achieved through attachment of a cooling device to the manifold extension 357, with or without angled portion 358.

While FIG. 2a depicts two manifolds 250 positioned within the interior of the convection section, there can be one, two or more manifolds 250 depending on the requirements of the project. The manifold 250 can be coated with a thermal barrier and/or be modified in other aspects to address the requirements of the project. By way of example, the thermal barrier can be the same as or similar to that of the high temperature coating applied to the panels 211 of the convection section.

Also contemplated by the invention is the monitoring and control of pressure within the convection section. The pressure can be controlled before it gets to the manifold 250 by the chilling or heating equipment. There can be access to measure the pressure inside the convection section by using a manometer (or other pressure measurement tools). The pressure release can be achieved via vents in the top and bottom panels (not shown) of the convection section. These vents can be opened during heating and cooling, which will help create air movement to create a scrubbing action that dissipates the heating and cooling more evenly.

Also contemplated are remote capabilities to monitor the metal temperatures, which can drive how much chilling/cooling or heat to be applied within the convection section. Safety features on the equipment can be manual or remote. The overall process provides safety as it reduces the number of people required to attach temporary heating elements 232. Reduced heating elements 232 means reduced temporary cabling, and reduced cabling means reduced job site clutter. The process also reduces the number of total kilowatts required for the job, which reduces the temporary power and carbon emissions into the atmosphere.

The temporary, mobile convection apparatus 200 can be positioned to best perform the heat treatment for each job. Each job can have varying requirements related to metals and alloys, size and thickness of the weld substrate, and angles and curvatures of the weld substrate. Thus, the requirements for pre-heating and post-weld cooling are optimized by efficient placement of the temporary, mobile convection apparatus 200. Placement is important for maximizing the heated band 234 and the heated gradient bands 236. The placement is most important to ensure adequate temperatures are achieved across the connected metal materials at and near the weld site 220, wherein there is homogeneity or near homogeneity across the hardness levels or zones.

While pressure vessels are discussed above, the instant invention provides for ship repair, weld interpass cooling control, pre-heat and post-weld heat treatment to any form of piping and any size, pressure and non-pressure vessels, tanks of any size, temporary furnace applications, power plant boilers, power plant drums and headers, valves and fittings, and hydrogen bake out after welding.

### EXAMPLES

Trial 1: External Heat—Internal Mimicked Convection Section

In this trial, it is shown that certain desired temperatures can be achieved with the claimed invention with less resources, e.g., less heaters (and less energy expenditure). The results demonstrate that embodiments of the disclosed invention achieve desired temperatures, provide improved temperature control, and improved energy efficiency. In this trial, insulation was used to create or mimic the convection section(s) described above.

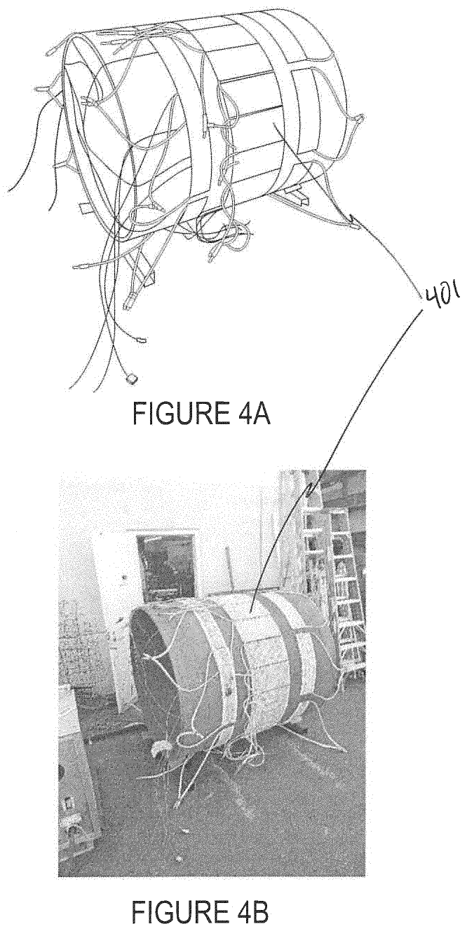

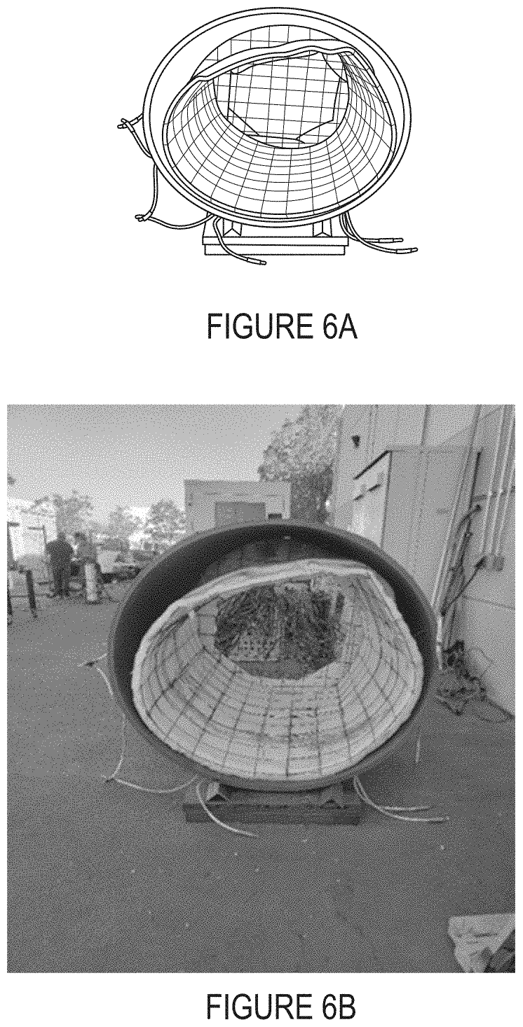

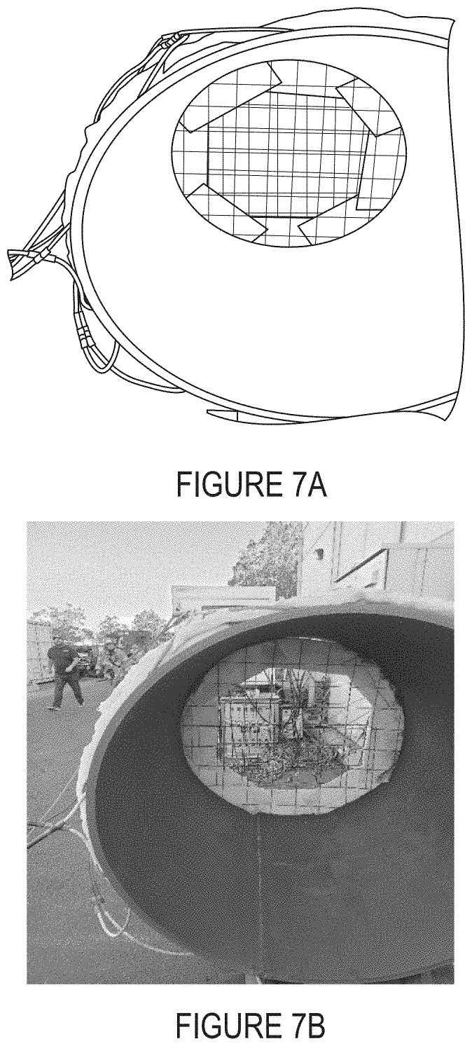

The test piece was a 54″ OD×1″ wall thickness by 5 ft long carbon steel pipe positioned horizontally. Temporary ceramic fiber insulation, 1 inch thick with a 6 #density was set up internally to mimic panels (convection section). A 4″ gap was created between the pipe internal and the temporary insulation to mimic where the panels would be. Heaters and thermocouples were set up sufficient to achieve temperature profiles in accordance with ASME Section VIII thermocouples and additional addendums as shown in FIGS. 4-17.

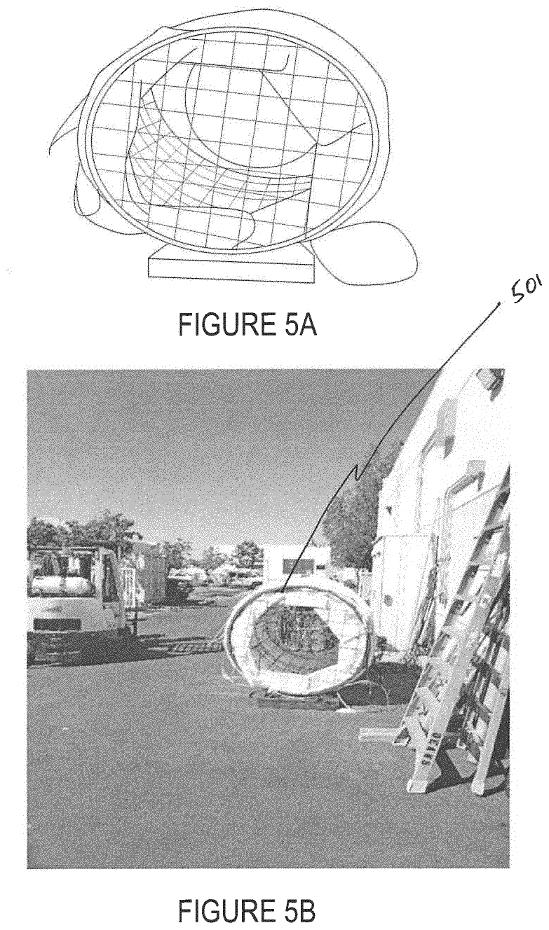

As shown in FIGS. 4a and 4b, a total of 33 heating elements (401) were used: 21 heating elements rated at 3.6 kW for an output of 76.6 kW and 12 heating elements at 1.8 kW with an output of 21.6 kW for total of 98.2 kW. The work piece was insulated on opposing sides (inner and outer) using 1″×6 #density ceramic fiber, positioned on the outside of the work piece to retain the heat in the manner of a Post Weld Heat Treatment (PWHT). As shown in FIGS. 5(a) and 5(b), the ends of the work piece were left open, and a 4″ gap (501) was created and a temporary bulkhead was used to support the meshed area of internal insulation as shown in FIGS. 4-7. The aforementioned gap between the internal insulation and the substrate allowed for the convection of heat.

Heat was applied and controlled through heat treatment control consoles that were powered by a temporary generator. In this trial, the temperature was brought up to 1150° F.

Trial 1: Results & Analysis

The required temperature profiles were achieved in all relevant soak band, heated band and gradient band areas in accordance with specifications while using a 30% reduction in heaters compared to prior art methods. Table 1 shows the temperatures achieved for thermocouple (“TIC Number”) along with their location:

| | | | TARGET | TEMP |
|---|---|---|---|---|
| CHART 1 | | LOCATION | TEMP | ACHIEVED |
| T/C NUMBER | 1 | WELD | 1150 | 1150 |
| T/C NUMBER | 2 | WELD | 1150 | 1150 |
| T/C NUMBER | 3 | WELD | 1150 | 1150 |
| T/C NUMBER | 4 | WELD | 1150 | 1150 |
| T/C NUMBER | 5 | WELD | 1150 | 1150 |
| T/C NUMBER | NOT USED | NOT USED | NOT USED | NOT USED |
| T/C NUMBER | 7 | WELD | 1150 | 1150 |
| T/C NUMBER | 8 | WELD | 1150 | 1150 |
| T/C NUMBER | 9 | GRAD 1 | 850 | 1060 |
| T/C NUMBER | 10 | GRAD 1 | 850 | 1065 |
| T/C NUMBER | 11 | GRAD 2 | 850 | 1060 |
| T/C NUMBER | 12 | GRAD 2 | 850 | 1075 |
| CHART 2 | | LOCATION | TARGET TEMP | TEMP ACHIEVED |
| T/C NUMBER | 1 | OUTER GRAD | 700 | 800 |
| T/C NUMBER | 2 | OUTER GRAD | 700 | 780 |
| T/C NUMBER | 3 | OUTER GRAD | 700 | 875 |
| T/C NUMBER | 4 | OUTER GRAD | 700 | 805 |
| T/C NUMBER | 5 | EDGE HB | 1000 | 1070 |
| T/C NUMBER | NOT USED | NOT USED | NOT USED | NOT USED |
| T/C NUMBER | NOT USED | NOT USED | NOT USED | NOT USED |
| T/C NUMBER | NOT USED | NOT USED | NOT USED | NOT USED |
| T/C NUMBER | 9 | 12 O' CLOCK | REFERENCE | AIR TEMP |
| T/C NUMBER | 10 | 3 O'CLOCK | REFERENCE | AIR TEMP |
| T/C NUMBER | 11 | 6 O' CLOCK | REFERENCE | AIR TEMP |
| T/C NUMBER | 12 | 9 O' CLOCK | REFERENCE | AIR TEMP |

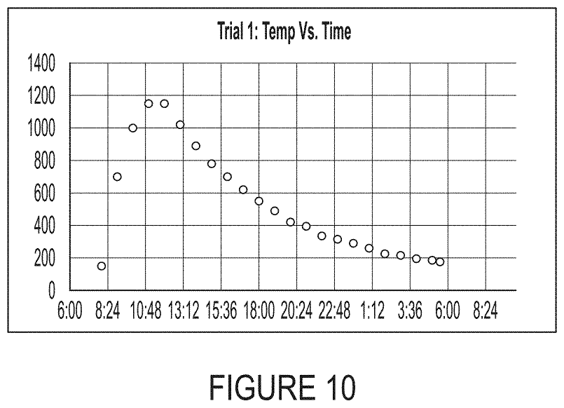

A typical heating set up allows for a 10% buffer for gaps between heaters, so the total coverage is 6732 sq inch/120 sq inch per heater, which equates to 56 heaters operating at 3.6 kW per heater, this produces a total of 201.6 kW. Trial 1, on the other hand, used a total of 33 heaters with 21 heaters rated at 3.6 kW, wherein those 33 heaters had an output of 76.6 kW and 12 heaters rated at 1.8 kW, wherein those 12 heaters had an output of 21.6 kW. Thus, the total output of the system of Trial 1 was 98.2 kW. This trial proved a 51.3% reduction in power used compared to the prior art method. Additionally, the cooling down phase from 800° F. to 180° F. was reduced to 14 hours. Table 2 shows the results achieved by Trial 1 (and illustrated in FIG. 10):

TABLE 2

| | | TEMP | | |
|---|---|---|---|---|
| | | HIGH | TARGET TEMP | |
| DATE | TIME | TEMP | BY CODE | |
| Sep. 6, 2020 | 8:00 | 150 | | |
| | 9:00 | 700 | 150 | |
| | 10:00 | 1000 | 700 | |
| | 11:00 | 1150 | 1100 | |
| | 12:00 | 1150 | 1150 | START |
| | | | | SOAK |
| | 13:00 | 1020 | 1150 | END |
| | | | | SOAK |
| | 14:00 | 890 | 800 | |
| | 15:00 | 780 | 400 | |
| | 16:00 | 700 | 120 | |
| | 17:00 | 620 | | |
| | 18:00 | 550 | | |
| | 19:00 | 490 | | |
| | 20:00 | 420 | | |
| | 21:00 | 395 | | |
| | 22:00 | 335 | | |
| | 23:00 | 315 | | |
| Sep. 6, 2020 | 0:00 | 290 | | |
| | 1:00 | 260 | | |
| | 2:00 | 225 | | |
| | 3:00 | 215 | | |
| | 4:00 | 195 | | |
| | 5:00 | 185 | | |
| | 5:30 | 175 | | |

Trial 2: External Heat—Internal Convection Box

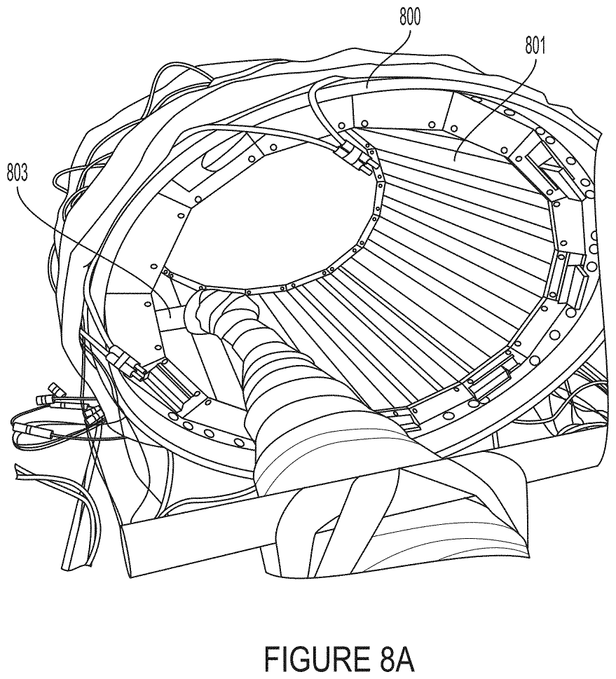

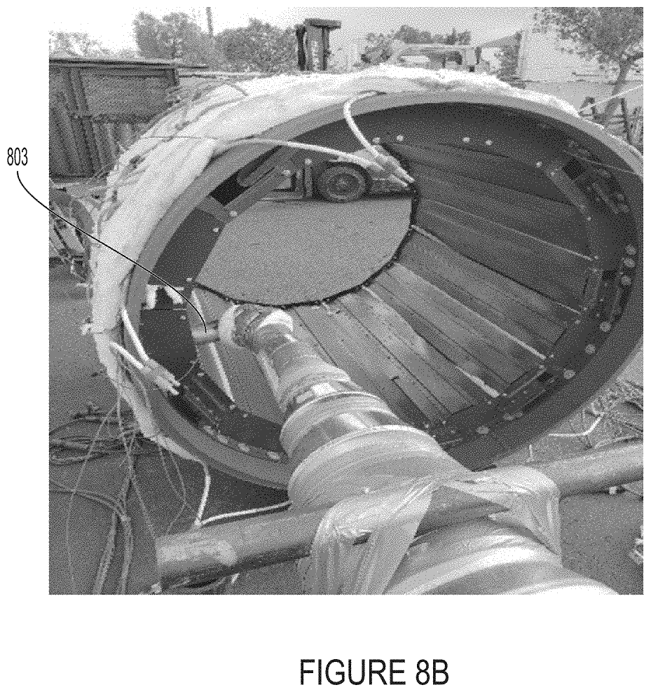

The work piece for this trial was a 54″ OD×1″ wall thickness by 5 ft long carbon steel pipe (800) positioned horizontally (FIGS. 8(a) and 8(b)). 16 sets of panels (801) were applied to the pipe section, serving as portions of the convection section, and brackets to the internal section of the pipe to form the convection section. The panels serving as sections of the convection section were secured with a stud gun and pin method that is commonly utilized to attach heating elements to work faces and would be understood by one of skill in the art in view of the present disclosure. A stud gun and pin method can be utilized to anchor brackets to the substrate that are used to attached panels to produce convection sections. Heaters, heating elements, thermocouples and insulation were added on the outside of the pipe as shown in FIGS. 8(a) and 8(b).

In the example, equipment such as heating cables and controls were connected to the heat treatment equipment. A total of 33 heaters (with necessary elements and components) were used: 21 heaters rated at 3.6 kW, which produced 76.6 kW and 12 heaters at 1.8 kW, which produced 21.6 kW for total of 98.2 kW. A manifold (803) was placed and all remaining connections were made for both heating and cooling. Temperature monitoring thermocouples were positioned where needed, e.g., on surface(s) of panels. At least one blower 901 (e.g., a 7.5 cfm blower) for the cooling phase was positioned as shown in FIGS. 8(a) and 8(b).

With the exemplary components of the disclosed invention adequately positioned, the controlled PWHT cycle is started. After achieving a peak 1150° F. temperature, the cooling phase was started until an 800° F. temperature was achieved.

Temperature monitoring equipment remained running after close down. The 120 degree target was achieved during normal cool down after switching off the cryogenic equipment.

Trial 2: Results & Analysis

The work piece temperature of 1150° F. was achieved per the configuration shown in FIGS. 8(a) and 8(b). As was seen in Trial 1, there was an approximate 50% reduction in power usage for the heating phase compared to prior art methods. When the cooling phase started, the temperature dropped from 800° F. to 180° F. in 3.5 hours. Trial 1 (the control) saw a temperature drop from 800° F. to 180° F. in about 14 hours, so Trial 2 (using aspects of the instant invention) reduced the cool down time by over 10 hours. Thus, Trial 2 cooling time was reduced by 75% compared to Trial 1. The temperature then fell due to ambient conditions from 180° F. to 120° F. in 1 hour. The external panel temperature was 600° F. during the heating phase.

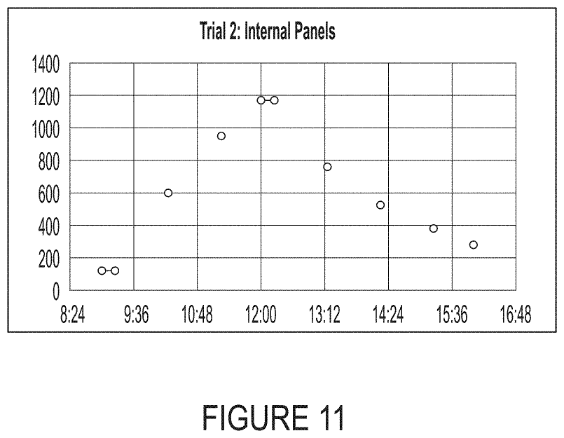

Table 3 below shows the Trial 2 temperature schedule (and illustrated in FIG. 11):

TABLE 3

| | | TEMP | TARGET | |
|---|---|---|---|---|
| | | HIGH | TEMP BY | |
| DATE | TIME | TEMP | CODE | |
| Nov. 6, 2020 | 9:00 | 120 | 150 | |
| | 9:15 | 120 | 150 | |
| | 10:15 | 600 | 600 | |
| | 11:15 | 950 | 1000 | |
| | 12:08 | 1170 | 1150 | |
| | 13:10 | 760 | 800 | ENGAGED FORCED |
| | | | | AIR COOLING, |
| | | | | OPEN VENTS |
| | 14:15 | 525 | 400 | |
| | 15:15 | 380 | 120 | |
| | 16:02 | 280 | | SWITCH OF |
| | | | | FORCED COOL |

Trial 3: Internal Heat—External Convection Box The work piece was a 54″ OD×1″ wall thickness by 5 foot long carbon steel (901) positioned vertically. 23 panels (902) (forming the convection box) and brackets were affixed to the external section of the pipe. The convection box panels were secured using the stud gun and pin method that is commonly utilized to attach heating elements to faces of the work piece whereby brackets were secured to the pipe using pins and the panels were attached to the brackets. Heaters (and related components) and thermocouples were set up internally on the pipe in sufficient numbers to achieve temperature profiles in accordance with ASME Section VIII. The face of the work piece was insulated using 1″×6 #density ceramic fiber (903) which was also used on the inside of the pipe to retain the heat as would be typical for a normal Post Weld Heat Treatment as shown in FIG. 10.

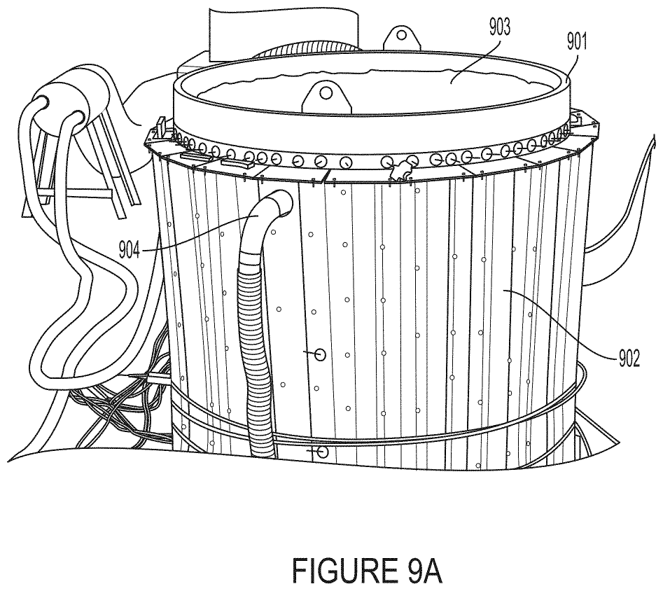

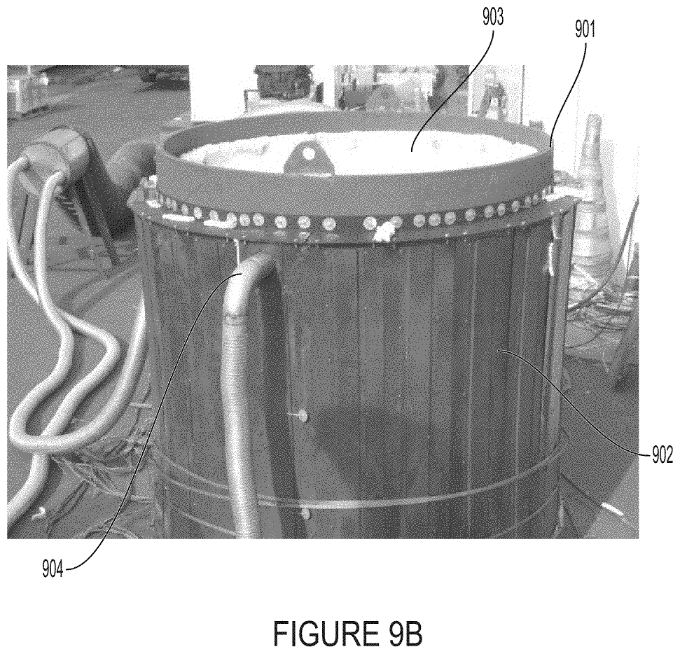

Heating cables and controls to heat treatment equipment were connected as shown in FIG. 10. A total of 30 heaters (and related components) were used, with 18 heaters rated at 3.6 kW having an output of 64.8 kW and 12 heaters rated at 1.8 kW for an output of 21.6 kW for a total of 86.4 kW. The manifold (904) and all remaining connections for both heat and cooling were assembled. Temperature monitoring thermocouples were positioned accordingly on external of panels. An adequate blower, e.g., 7500 cfm blower 1003, for cooling phase was connected to the manifold positioned as shown in FIGS. 9(a) and 9(b). The air manifold had two egress ports which connected to inlet ports through the panels to guide cooling inside the convection sections.

Trial 3: Results & Analysis

The temperature profiles were achieved in all areas during the PWHT cycle for soak band, edge of heated band and gradient control band for the size of pipe used. Cooling time was 4 hours from 800° F. to 135° F. which is a 75% reduction in cooling time from the control (Trial 1). The total heat of the 30 heaters used was 86.4 kW. The prior art industry standard would have used 52 heaters rated at 3.6 kW with an output of 187.2 kW for the same total coverage area and allowing for the same 10% buffer. A 1.5 kW blower was used during the cooling phase. Trial 3 achieved a 53% reduction in total KW used for trial compared to the industry standard.

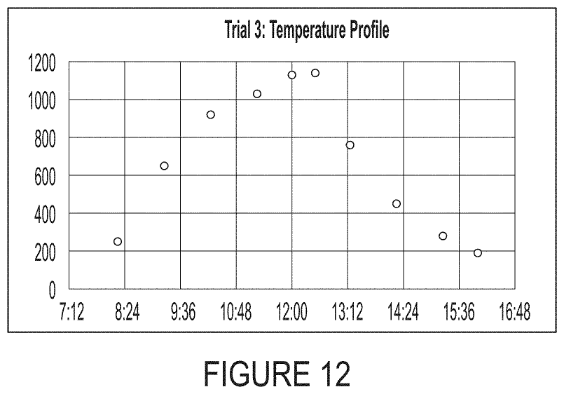

Table 4 below shows the temperature schedule for Trial 3 (and illustrated in FIG. 12):

TABLE 4

| | | TEMP | TARGET | |
|---|---|---|---|---|
| | | HIGH | TEMP BY | |
| DATE | TIME | TEMP | CODE | |
| Dec 16, 2020 | 8:15 | 250 | 150 | |
| | 9:15 | 650 | 150 | |
| | 10:15 | 920 | 600 | |
| | 11:15 | 1030 | 1000 | |
| | 12:00 | 1130 | 1150 | BEGIN SOAK |
| | 12:30 | 1140 | 1150 | END SOAK |
| | 13:10 | 760 | 800 | ENGAGE |
| | | | | FORCED COOL |
| | 14:15 | 450 | 400 | |
| | 15:15 | 280 | 120 | |
| | 16:02 | 190 | | |
| | 17:15 | 135 | | |

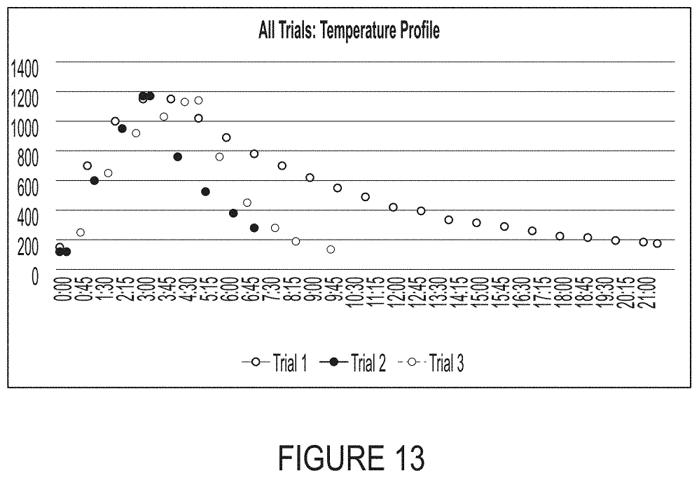

FIG. 13 shows the significant time reduction in Trials 1, 2, and 3 due to forced cooling compared to the prior art along with the comparative results of each trial. The disclosed embodiments and processes meet temperature specifications with over 50% reduction in power usage and a 75% reduction in cooling time compared to industry standard, prior art practices. These results are consistent with the panels on the interior and exterior of the pipe.

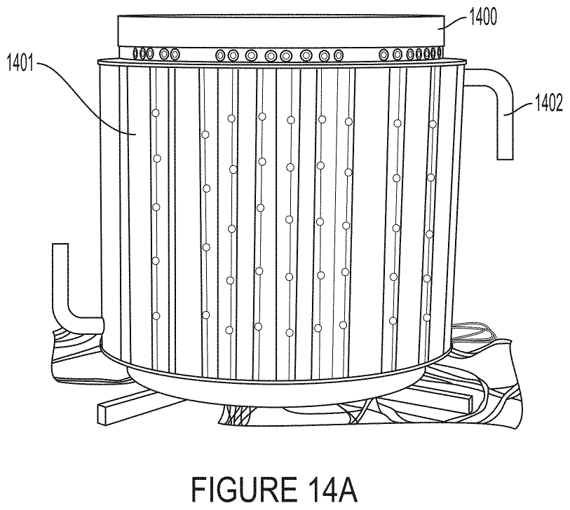

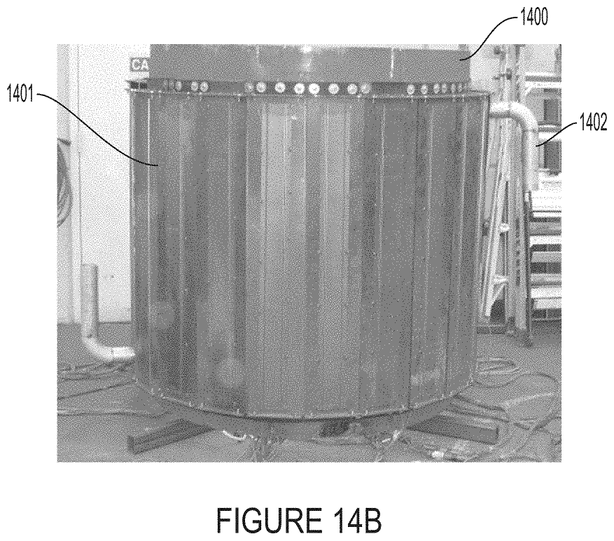

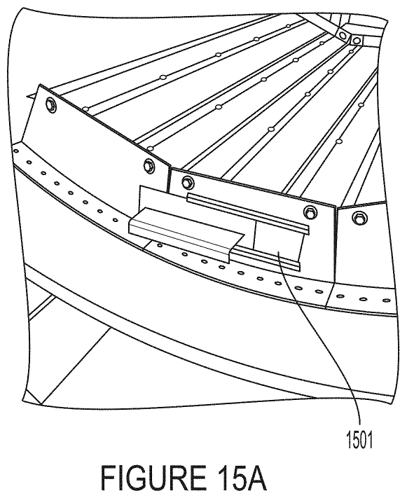

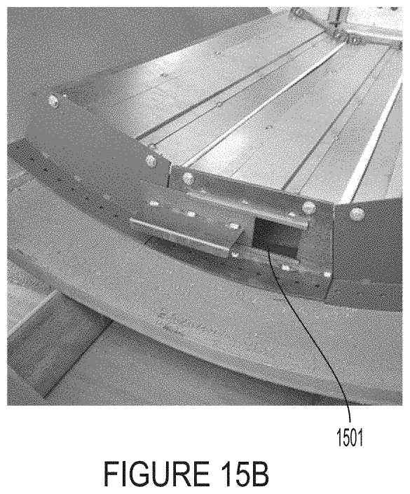

As will be understood by those of ordinary skill in the art, an apparatus disclosed herein is adaptable for placement for an internal or external welding. For example, heating components disclosed herein can be arranged about the exterior of a pipe work piece or the interior of a pipe work piece. Panels forming the convection box can be positioned about the interior or exterior of the work piece. These requirements will be determined by the job guidelines and/or based on the size, material, location, etc. of the structure to be welded, fabricated and/or repaired. FIGS. 14(a) and 14(b) show panels 1401 forming a convection box of the disclosed invention about the exterior of a work piece 1400. Also shown in FIGS. 14(a) and 14(b) is an angled inlet portion 1402 of a manifold of the disclosed invention. FIG. 14 also illustrates an internal convection box of the disclosed invention wherein an angled portion of a manifold inlet is demonstrated. Thus, the disclosed invention provides for both internal and external welds, for example, as shown in FIGS. 15(a) and 15(b) where the convection section is arranged on the inside of the pipe.

The connected panels forming a convection box of the disclosed invention can house at least one manifold system/apparatus. At least one end of at least one panel forming a portion of a convention box as described herein can have an operable vent to be engaged, opened, released, closed, disengaged, to prevent venting or to allow venting in and out of the convection box. By way of one embodiment, FIGS. 15(a) and 15(b) illustrate such a vent. Panel vents 1501 can be fabricated with the same or similar materials as that of the convection box panels, wherein the material is capable of remaining functional after exposure to the temperatures achieved during the processes discussed and disclosed herein. In one embodiment as shown in FIGS. 15(a) and 15(b), the panel end vent apparatus is designed as a slidable vent capable of sliding to either side, whether the convection box is internal or external to the work piece. The slidable vent can be adjusted during heating of the convection box to adjust the temperature inside of the convection box. In this way, the panel end vent can operate as a damper. Embodiments of the invention can include any and all of the features discussed in Trials 1-3, including panel vents as disclosed herein.

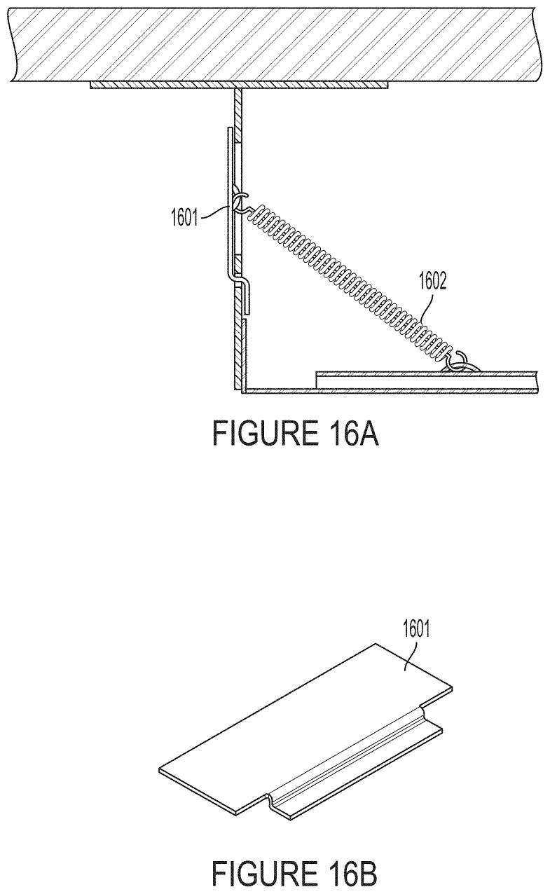

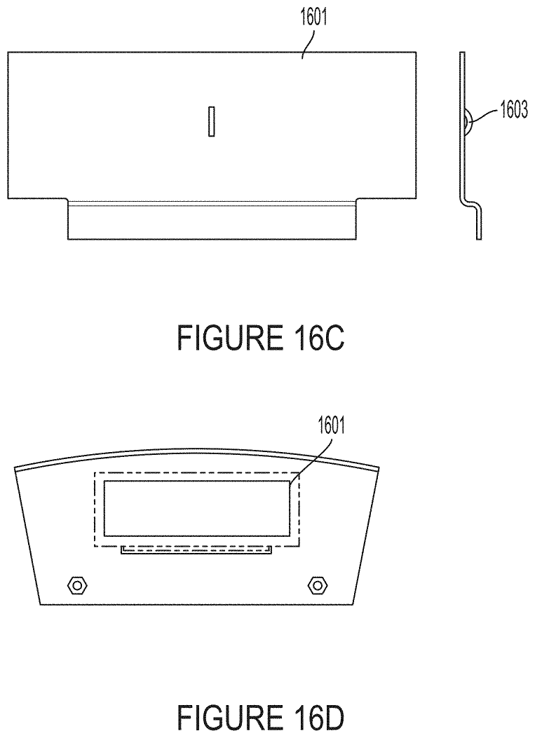

In some embodiments, a panel end vent apparatus can be engaged through a spring system (FIG. 16(a)). A panel end vent with a spring system allows the convection box to remain sealed while the substrate is being heated, and the spring loaded panel end vent is configured to open when a blower is engaged to cool the convection box. In some embodiments, the pressure increase in the convection box caused by the blower can cause the panel end vent (1601) with a spring system (1602) to open. FIG. 16(b) shows the panel end vent that is retained in place via the spring system (1602) shown in FIG. 16(a), which opens when, e.g., a manifold blower is engaged, forcing the panel open to vent the convection section for cooling or control of the rate of heating and/or temperature inside the convection box. FIG. 16(c) illustrates a top view of a panel end vent (1601) used in conjunction with the spring system shown in FIG. 16(a). Panel end vent (1601) can include an eyelet (1603) that is configured to interface with spring system (1602). FIG. 16(d) depicts a valve flap of the spring loaded panel end vent when positioned in the end of a convection panel or a bracket portion of a convection panel. As will be appreciated, the dimensions of FIGS. 16(a)-(d) are illustrative only and will be adjusted as necessary based on the guidelines and requirements of each job to be performed in view of the instant disclosure.

Although the foregoing description is directed to the preferred embodiments of the invention, it should be noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A temporary and mobile convection apparatus for preheating a substrate requiring welds, said apparatus comprising:
a convection box comprising:
one or more panels and
one or more manifolds for heating or cooling one side of the substrate;
an external insulation material; and
an external heating system comprising one or more heaters.

2. The apparatus of claim 1, wherein the external insulation material and the external heating system are positioned on an opposite side of the substrate than the convection box.

3. The apparatus of claim 1, wherein the external heating system comprises one or more external heaters.

4. The apparatus of claim 3, wherein the multiple external heaters are positioned to create a predetermined heat band and multiple heat gradient bands.

5. The apparatus of claim 4, wherein the multiple heat gradient bands comprise two outer bands configured to achieve a temperature with the external insulation and through heat from the internal convection box.

6. The apparatus of claim 5, wherein the convection section comprises a panel coated with a high temperature coating adapted to contain heat within the internal convection box.

7. The apparatus of claim 1, wherein the manifold is an internal cooling or heating manifold.

8. The apparatus of claim 7, wherein the internal manifold comprises an extension, pipes and throttles.

9. The apparatus of claim 8, wherein the extension passes through a barrier or wall of the panel of the internal convection box.

10. The apparatus of claim 9, wherein the extension is connected to a chilling or heating device.

11. The apparatus of claim 10, wherein the pipes pass internally through an interior of the internal convection box, and wherein each pipe comprises a terminus throttle.

12. The apparatus of claim 11, wherein a diameter, length and material of the manifold are predetermined.

13. A method of welding sections of a vessel, wherein the method comprises using the temporary, mobile convection apparatus of claim 1.

14. A method of preheating sections of a vessel for welding, wherein the method comprises using the temporary, mobile convection apparatus of claim 1.

15. A temporary and mobile convection apparatus for fabricating products requiring welds, said apparatus comprising:
a internal convection box comprising,
a panel and
a manifold; and
an external cooling system.

16. The apparatus of claim 15, wherein the internal manifold comprises an extension, pipes and throttles.

17. The apparatus of claim 16, wherein the extension passes through a barrier or wall of the panel of the internal convection box.

18. The apparatus of claim 17, wherein the extension is adapted to be connected to a chilling device.

19. The apparatus of claim 18, wherein the pipes pass internally through an interior of the internal convection box, and wherein each pipe comprises a terminus throttle.

20. The apparatus of claim 19, wherein a diameter, length and material of the manifold are predetermined.

21. A method of rapidly cooling welded sections of a vessel, wherein the method comprises using the temporary, mobile convection apparatus of claim 15.

22. A method of rapidly cooling sections of a vessel with higher than ambient temperatures due to welding, wherein the method comprises using the temporary, mobile convection apparatus of claim 15.
